(19) United States
(12) Patent Application Publication
(10) Pub. No.: US 2022/0284547 A1
(43) Pub. Date: Sep. 8, 2022

(54) SUPER-RESOLUTION IMAGE RECONSTRUCTION METHOD BASED ON DEEP CONVOLUTIONAL SPARSE CODING

(71) Applicant: Southwest University, Chongqing (CN)

(72) Inventors: Jianjun Wang, Chongqing (CN); Ge Chen, Chongqing (CN); Jia Jing, Chongqing (CN); Weijun Ma, Chongqing (CN); Xiaohu Luo, Chongqing (CN)

(21) Appl. No.: 17/677,625

(22) Filed: Feb. 22, 2022

(30) Foreign Application Priority Data
Feb. 22, 2021 (CN) 202110196819 .X

(51) Int. Cl. G06T 3/40; G06N 3/08

(52) U.S. Cl. CPC G06T 3/4053; G06N 3/084

(57) ABSTRACT

An SR image reconstruction method based on deep convolutional sparse coding (DCSC) is provided. The method includes: embedding a multi-layer learned iterative soft thresholding algorithm (ML-LISTA) of a multi-layer convolutional sparse coding (ML-CSC) model into a deep convolutional neural network (DCNN), adaptively updating all parameters of the ML-LISTA with a learning ability of the DCNN, and constructing an SR multi-layer convolutional sparse coding (SRMCSC) network which is an interpretable end-to-end supervised neural network for SR image reconstruction; and introducing residual learning, extracting a residual feature with the ML-LISTA, and reconstructing a high-resolution (HR) image in combination with the residual feature and an input image, thereby accelerating a training speed and a convergence speed of the SRMCSC network. The SRMCSC network provided by the present disclosure has the compact structure and the desirable interpretability, and can generate visually attractive results to offer a practical solution for the SR reconstruction.

### CROSS REFERENCE TO RELATED APPLICATIONS

This patent application claims the benefit and priority of Chinese Patent Application No. 202110196819.X, entitled “SUPER-RESOLUTION IMAGE RECONSTRUCTION METHOD BASED ON DEEP CONVOLUTIONAL SPARSE CODING”, filed with the Chinese State Intellectual Property Office on Feb. 22, 2021, which is incorporated by reference in its entirety herein.

### TECHNICAL FIELD

The present disclosure belongs to the technical field of super-resolution (SR) image reconstruction, and particularly relates to an SR image reconstruction method based on deep convolutional sparse coding (DCSC).

### BACKGROUND ART

Currently, as a classical problem in digital imaging and computer low-level vision, SR image reconstruction aims to construct high-resolution (HR) images with single-input low-resolution (LR) images, and has been widely applied to various fields from security and surveillance imaging to medical imaging and satellite imaging requiring more image details. Since visual effects of the images are affected by imperfect imaging systems, transmission media and recording devices, there is a need to perform the SR reconstruction on the images to obtain high-quality digital images.

In recent years, the SR image reconstruction method has been widely researched in the computer vision, and the known SR image reconstruction methods are mainly classified into two types of methods, namely the interpolation-based methods and the modeling-based methods. The interpolation-based methods such as Bicubic interpolation and Lanzcos resampling methods will cause the over-smoothing phenomenon of the images in spite of the high implementation efficiency. On the contrary, iterative back projection (IBP) methods may generate images with over sharpened edges. Hence, many image interpolation methods are applied to a post-processing (edge sharpening) stage of the IBP methods. The modeling-based methods are intended to use mappings from LR images to HR images for modeling. For example, sparse coding methods are to reconstruct HR image blocks with sparse representation coefficients of LR image blocks, and such sparse prior-based methods are typical SR reconstruction methods; self-similarity methods are to add structural self-similarity information of LR image blocks to the reconstruction process of the HR images; and neighbor embedding methods are to embed neighbors of LR image blocks into nearest atoms in dictionaries and pre-calculate corresponding embedded matrices to reconstruct HR image blocks. During solving of these methods, each step is endowed with specific mathematical and physical significances, which ensures that these methods can be interpreted and correctly improved under the theoretical guidance. and yield the desirable effect; and particularly, sparse models gain significant development in the field of SR reconstruction. Nevertheless, there are usually two main defects for most of these methods, specifically, the methods are complicated in term of calculation during optimization, making the reconstruction time-consuming; and these methods involve manual selection of many parameters, such that the reconstruction performance is to be improved to some extent.

In order to break through limitations of the above classical methods, the deep learning-based model as a pioneer, namely the SR convolutional neural network (SRCNN), emerges and brings a new direction. The method predicts the mapping from nonlinear LR images to HR images through a fully convolutional network (FCN), indicating that all SR information is obtained through data learning, namely parameters in the network are adaptively optimized through backpropagation (BP). This method makes up the shortages of the classical learning methods and yields better performance. However, the above method has its limitations, specifically, the uninterpretable network structure can only be designed through repeated testing and is hardly improved; and the method depends on the context of small image regions and is insufficient to restore the image details. Therefore, a novel SR image reconstruction method is to be provided urgently.

Through the above analysis, there are the following problems and defects in the prior art:

(1) The existing SRCNN structure is uninterpretable and can only be designed through repeated testing and is hardly improved; and

(2) the existing SRCNN depends on the context of the small image regions and is insufficient to restore the image details.

The difficulties for solving the above problems and defects lie in that: the existing SRCNN structure is uninterpretable and can only be designed through repeated testing and is hardly improved; and the structure depends on the context of the small image regions and is insufficient to restore the image details.

Solving the above problems and defects are helpful in: breaking through the limitations of the classical methods; the interpretability of the network being able to instruct us to design a better network architecture to improve the performance, rather than stack network layers simply; and expanding the context of the image regions to better restore the image details.

### SUMMARY

In view of the problems of the conventional art, the present disclosure provides an SR image reconstruction method based on DCSC.

The present disclosure is implemented as follows: An SR image reconstruction method based on DCSC includes the following steps:

step 1: embedding a multi-layer learned iterative soft thresholding algorithm (ML-LISTA) into a deep convolutional neural network (DCNN), adaptively updating all parameters of the ML-LISTA with a learning ability of the DCNN, and constructing an SR multi-layer convolutional sparse coding (SRMCSC) network which is an interpretable end-to-end supervised neural network for SR image reconstruction, where an interpretability of the network may be helpful to better design a network architecture to improve performance, rather than simply stack network layers; and

step 2: introducing residual learning, extracting a residual feature with the ML-LISTA, and reconstructing an HR image in combination with the residual feature and an input image, thereby accelerating a training speed and a convergence speed of the SRMCSC network.

In some embodiments, in constructing a multi-layer convolutional sparse coding (ML-CSC) model in step 1:

sparse coding (SC) is implemented to find a sparsest representation γ∈R^{M} of a signal y∈R^{N} in a given overcomplete dictionary A∈R^{N×M}(M>N), which is expressed as y=Aγ; and a γ problem which is also called a Lasso or [symbol] ₁ regularization BP problem is solved:

$${min}_{γ} \frac{1}{2} {‖ y - A γ ‖}_{2}^{2} + α {‖ γ ‖}_{1} \qquad ( 1 )$$

where, a constant α is used to weigh a reconstruction item and a regularization item; and an update ecmation of an iterative soft thresholding algorithm (ISTA) may be written as:

$$\begin{matrix}{γ}^{i + 1} = {S}_{\frac{α}{L}} ( {γ}^{i} - \frac{1}{L} ( - {A}^{T} y + {A}^{T} A {γ}^{i} ) ) \\ = {S}_{\frac{α}{L}} ( \frac{1}{L} {A}^{T} y + ( I - \frac{1}{L} {A}^{T} A ) {γ}^{i} )\end{matrix} \qquad ( 2 )$$

where, γⁱ represents an ith iteration update, L is a Lipschitz constant, and Sρ(·)is a soft thresholding operator with a threshold ρ; and the soft thresholding operator is defined as follows:

$${S}_{ρ} ( z ) = \{ \begin{matrix}z + ρ , & z < - ρ \\ 0 , & - ρ \leq z \leq ρ \\ z - ρ , & z > ρ\end{matrix} .$$

In some embodiments, constructing an ML-CSC model in step 1 may further include: proposing a convolutional sparse coding (CSC) model to perform SC on a whole image, where the image may be obtained by performing convolution on m local filters dᵢ,∈Rⁿ(n<<N) and corresponding feature maps γᵢ∈R^{N} thereof and linearly combining resultant convolution result, which is expressed as

$$x = {\sum }_{i = 1}^{m} {d}_{i} * {γ}_{i} ;$$

and corresponding to equation (1), an optimization problem of the CSC model may be written as:

$${min}_{{γ}_{i}} \frac{1}{2} {‖ y - {\sum }_{i = 1}^{m} {d}_{i} * {γ}_{i} ‖}_{2}^{2} + α {‖ {\sum }_{i = 1}^{m} {γ}_{i} ‖}_{1} \qquad ( 3 )$$

and

converting the filters into a banded circulant matrix to construct a special global convolutional dictionary D∈R^{N×mN}, thereby x=Dγ, where in the convolutional dictionary D, all small blocks each serve as a local dictionary, and have a same size of nxm elements, with filters {dᵢ}ᵢ₌₁^{m} as respective columns; the CSC model (3) may be considered as a special form of an SC model (1), matrix multiplication in equation (2) of the ISTA is replaced by a convolution operation, and the CSC problem (3) may also be solved by the LISTA.

A thresholding operator may be a basis of a convolutional neural network (CNN) and the CSC model; by comparing a rectified linear unit (ReLU) in the CNN with a soft thresholding function, the ReLU and the soft thresholding function may keep consistent in a non-negative part; and for a non-negative CSC model, a corresponding optimization problem (1) may be added with a constraint to allow a result to be positive:

$${min}_{γ} \frac{1}{2} {‖ y - D γ ‖}_{2}^{2} + α {‖ γ ‖}_{1} s . t . γ \geq 0. \qquad ( 4 )$$

naturally, a resulting problem may be whether the constraint affects an expressive ability of an original sparse model; as a matter of fact, there may be no doubt because a negative coefficient of the original sparse model may be transferred to a dictionary; and for a given signal y=Dγ, the signal may be written as:

y=D_{γ}_{₊}+(−D)(−γ₋) (5)

where, γ may be divided into γ+ and γ−, γ+ includes a positive element, γ− includes a negative element, and both the γ+ and the −γ− are non-negative; apparently, a non-negative sparse representation [γ+ −γ−]^{T} may be allowable for the signal y in a dictionary [D −D]; and therefore, each SC may be converted into non-negative SC (NNSC), and the NNSC problem (4) may also be solved by the soft thresholding algorithm; a non-negative soft thresholding operator Sρ⁺ is defined as:

$${S}_{ρ}^{+} ( z ) = \{ \begin{matrix}0 , & z \leq ρ \\ z - ρ , & z > ρ\end{matrix} .$$

meanwhile, assuming that γ⁰=0, an iteration update of γ in the problem (4) may be written as:

$${γ}^{1} = {S}_{\frac{α}{L}}^{+} ( \frac{1}{L} ( {D}^{T} y ) ) \qquad ( 6 )$$

the non-negative soft thresholding operator is equivalent to an ReLU function:

S_{ρ}⁺(z)=max(z−ρ,0)=ReLU(z−ρ) (7)

therefore, equation (6) is equivalently written as:

$$\begin{matrix}{γ}^{1} = {S}_{\frac{α}{L}}^{+} ( \frac{1}{L} ( {D}^{T} y ) ) \\ = ReLu ( {W}_{y} - b )\end{matrix} \qquad ( 8 )$$

where, a bias vector b corresponds to a threshold

$$\frac{α}{L} ,$$

and in other words, α is a hyper-parameter in the SC, but a learning parameter in the CNN; furthermore, dictionary learning may be completed through D=W^{T}; and therefore, the non-negative soft thresholding operator for the CSC model is closely associated with the CNN.

In some embodiments, constructing an ML-CSC model in step 1 may further include:

assuming that a convolutional dictionary D may be decomposed into multiplication of multiple matrices, namely x=D₁D₂ . . . D_{LγL}; and describing the ML-CSC model as:

$$\begin{matrix}x = {D}_{1} {γ}_{1} \\ {γ}_{1} = {D}_{2} {γ}_{2} \\ {γ}_{2} = {D}_{3} {γ}_{3} \\ … \\ {γ}_{L - 1} = {D}_{L} {γ}_{L}\end{matrix}$$

where, γᵢ is a sparse representation of an ith layer and also a signal of an (i+1)th layer, and Dᵢ, is a convolutional dictionary of the ith layer and a transpose of a convolutional matrix; an effective dictionaryl {Dᵢ}ᵢ^{L=}1 serves as an analysis operator for causing a sparse representation of a shallow layer to be less sparse; consequently, different representation layers are used in an analysis-based prior and a synthesis-based prior, such that prior information may not only constrain a sparsity of a sparse representation of a deepest layer, but also allows the sparse representation of the shallow layer to be less sparse; the ML-CSC is also a special form of an SC(1) model; and therefore, for a given signal γₒ=γ, an optimization object of the ith layer in the ML-CSC model may be written as:

$${min}_{{γ}_{i}} \frac{1}{2} {‖ {γ}_{i - 1} - {D}_{i} {γ}_{i} ‖}_{2}^{2} + {α}_{i} {‖ {γ}_{i} ‖}_{1} \qquad ( 9 )$$

where, αᵢ, is a regularization parameter of the ith layer; similar to equation (2), the ISTA is used to obtain an update of γ [symbol] in the problem (9); the ISTA is repeated to obtain an ML-ISTA of {γᵢ}ᵢ^{L=}, and the ML-ISTA converges at a rate of

$$O ( \frac{1}{k} )$$

to a globally optimal solution of the ML-CSC; and proposing the ML-LISTA which is configured to be approximate to the SC of the ML-ISTA through learning parameters from data,

where, (I−Wᵢ^{T}Wᵢ) \hat{γ}ᵢ+Bᵢ^{T}γᵢ₋₁^{k+1} replaces an iterative operator

$$( I - \frac{1}{{L}_{i}} {D}_{i}^{T} {D}_{i} ) {\hat{γ}}_{i} + \frac{1}{{L}_{i}} {D}_{i}^{T} {γ}_{i - 1}^{k + 1}$$

a dictionary Dᵢ, in the ML-LISTA is decomposed into two dictionaries Wᵢ, and Bᵢ with a same size, and the dictionaries Wᵢ, and Bᵢ each are also constrained as a convolutional dictionary to control a number of parameters; and if a deepest sparse representation with an initial condition of γ_{L}¹=0 is found through only one iteration, the representation may be rewritten as:

γL=P_{ρL}((B_{L}^{T}P_{ρL-1}( . . . P_{ρ1}(B₁^{T}y)))) (10)

In some embodiments, if a non-negative assumption similar to equation (4) is made to a sparse representation coefficient, a thresholding operator P may be a non-negative projection; a process of obtaining a deepest sparse representation may be equivalent to that of obtaining a stable solution of a neural network, namely forwarding propagation of the CNN may be understood as a tracing algorithm for obtaining a sparse representation with a given input signal; a dictionary Dᵢ in the ML-CSC model may be embedded into a learnable convolution kernel of each of the Wᵢ and the Bᵢ, namely a dictionary atom in Bᵢ^{T} (or Wᵢ^{T}) may represent a convolutional filter in the CNN, and the Wᵢ and the Bᵢ each may be modeled with an independent convolutional kernel; and a threshold ρᵢ may be parallel to a bias vector b₁, and a non-negative soft thresholding operator may be equivalent to an activation function ReLU of the CNN.

In some embodiments, establishment of the SRMCSC network may include two steps: an ML-LISTA feature extraction step and an HR image reconstruction step; the network may be an end-to-end system, with an LR image y as an input, and a directly generated and real HR image x as an output; and a depth of the network may be only related to a number of iterations.

Further, in step 1, each layer and each skip connection in the SRMCSC network may strictly correspond to each step of a processing flow of a three-layer LISTA, an unfolded algorithm framework of the three-layer LISTA may serve as a first constituent part of the SRMCSC network, and first three layers of the network may correspond to a first iteration of the algorithm; a middle hidden layer having an iterative update in the network may include update blocks; and thus the proposed network may be interpreted as an approximate algorithm for solving a multi-layer BP problem.

Further, in step 2, the residual learning may be implemented by performing K iterations to obtain a sparse feature mapping γ_{S}^{K}, estimating a residual image according to a definition of the ML-CSC model and in combination with the sparse feature mapping and a dictionary, an estimated residual image U mainly including highly frequent detail information, and obtaining a final HR image x through equation (11) to serve as a second constituent part of the network:

x=U+y (11).

Performance of the network may only depend on an initial value of a parameter, a number of iterations K and a number of filters; and in other words, thereof the network may only increase the number of iterations without introducing an additional parameter, and parameters of the filters to be trained by the model may only include three dictionaries with a same size.

Further, a loss function that is a mean squared error (MSE) may be used in the SRMCSC network:

N training pairs {yᵢ, xᵢ}ᵢ₌₁^{N}, namely LR-HR patch pairs, may be given to minimize a following objective function:

$$L ( Θ ) = {\sum }_{i = 1}^{N} {‖ f ( {y}_{i} ; Θ ) - {x}_{i} ‖}_{F}^{2} ,$$

where, ƒ(·) is the SRMCSC network, Θ represents all trainable parameters, and an Adam optimization program is used to optimize the parameters of the network.

Another object of the present disclosure is to provide a computer program product stored on a non-transitory computer readable storage medium, including a computer readable program, configured to provide, when executed on an electronic device, a user input interface to implement the SR image reconstruction method based on DCSC.

Another object of the present disclosure is to provide a non-transitory computer readable storage medium, storing instructions, and configured to enable, when run on a computer, the computer to execute the SR image reconstruction method based on DCSC.

With the above technical solutions, the present disclosure has the following advantages and beneficial effects: The SR image reconstruction method based on DCSC provided by the present disclosure proposes the interpretable end-to-end supervised neural network for the SR image reconstruction, namely the SRMCSC network, in combination with the ML-CSC model and the DCNN. The network has the compact structure, easy implementation and desirable interpretability. Specifically, the network is implemented by embedding the ML-LISTA into the DCNN, and adaptively updating all parameters in the ML-LISTA with the strong learning ability of the DCNN. Without introducing additional parameters, the present disclosure can get a deeper network by increasing the number of iterations, thereby expanding context information of a receiving domain in the network. However, while the network gets deeper gradually, the convergence speed becomes a key problem for training. Therefore, the present disclosure introduces the residual learning, extracts the residual feature with the ML-LISTA, and reconstructs the HR image in combination with the residual feature and the input image, thereby accelerating the training speed and the convergence speed. In addition, compared with multiple state-of-the-art relevant methods, the present disclosure yields the best reconstruction effect qualitatively and quantitatively.

### BRIEF DESCRIPTION OF THE DRAWINGS

To describe the technical solutions in embodiments of the present disclosure more clearly, the following briefly describes the accompanying drawings that need to be used in the embodiments. Apparently, the accompanying drawings in the following description show merely some embodiments of the present disclosure, and a person of ordinary skills in the art may derive other drawings from these accompanying drawings without creative efforts.

FIG. 1 is a framework diagram of an SRMCSC network for SR reconstruction according to an embodiment of the present disclosure.

FIG. 2 is a schematic diagram of a difference between an LR image and an HR image according to an embodiment of the present disclosure.

FIG. 3 is a schematic diagram of a convolutional dictionary D according to an embodiment of the present disclosure.

FIG. 4 is a schematic diagram of a soft thresholding operator with a threshold ρ=2 and an ReLU function according to an embodiment of the present disclosure.

FIG. 5 is a schematic diagram of a peak signal-to-noise ratio (PSNR) (dB) value and a visual effect of a picture “butterfly” (Set5) under a scale factor of 3 according to an embodiment of the present disclosure.

FIG. 6 is a schematic diagram of a PSNR (dB) value and a visual effect of a picture “woman” (Set5) under a scale factor of 3 according to an embodiment of the present disclosure.

FIG. 7 is a flow chart of an SR image reconstruction method based on DCSC according to an embodiment of the present disclosure.

### DETAILED DESCRIPTION OF THE EMBODIMENTS

To make the objects, technical solutions and advantages of the present disclosure clearer and more comprehensible, the present disclosure will be further described below in detail in conjunction with embodiments. It should be understood that the specific embodiments described herein are merely intended to explain but not to limit the present disclosure.

In view of the problems of the prior art, the present disclosure provides an SR image reconstruction method based on DCSC. The present disclosure is described below in detail in combination with the accompanying drawings.

As shown in FIG. 7, the SR image reconstruction method based on DCSC provided by the embodiment of the present disclosure includes the following steps.

In step S101, the ML-LISTA of ML-CSC model is embedded into DCNN, to adaptively update all parameters in the ML-LISTA with a learning ability of the DCNN, and thus an interpretable end-to-end supervised neural network for SR image reconstruction, namely an SRMCSC network is construed.

In step S102, residual learning is introduced, to extract a residual feature with the ML-LISTA, and reconstruct an HR image in combination with the residual feature and an input image, thereby accelerating a training speed and a convergence speed of the SRMCSC network.

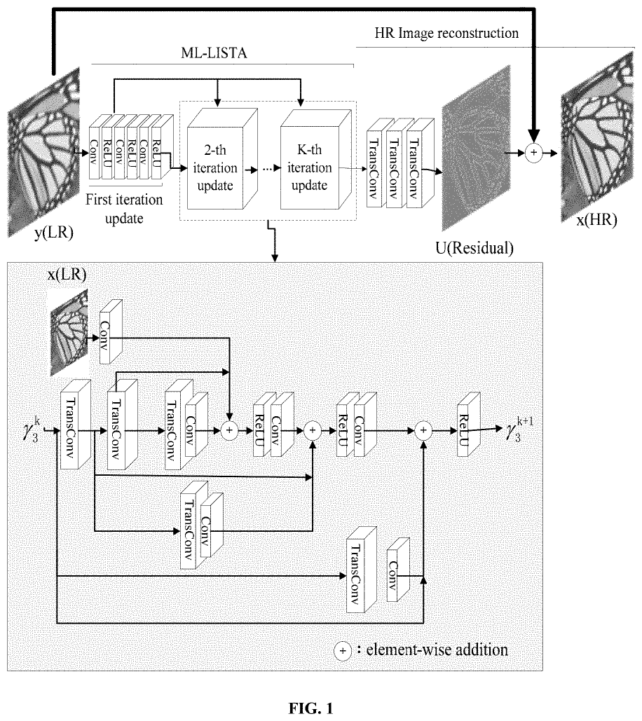

The SR image reconstruction method based on DCSC according to the present disclosure may also be implemented by the person of ordinary skills in the art with other steps. FIG. 1 illustrates an SR image reconstruction method based on DCSC according to the present disclosure, which is merely a specific embodiment.

Technical solutions of the present disclosure are further described below in conjunction with the embodiments.

### 1. Overview

The present disclosure proposes the interpretable end-to-end supervised neural network for the SR image reconstruction, namely the SRMCSC network, in combination with the ML-CSC model and the DCNN. The network has the compact structure, easy implementation and desirable interpretability. Specifically, the network is implemented by embedding the ML-LISTA into the DCNN, and adaptively updating all parameters in the ML-LISTA with the strong learning ability of the DCNN. Without introducing additional parameters, the present disclosure can obtain a deeper network by increasing the number of iterations, thereby expanding context information of a receptive field in the network. However, while the network gets deeper gradually, the convergence speed becomes a key problem for training. To solve this problem, the present disclosure introduces the residual learning, to extract the residual feature with the ML-LISTA, and reconstruct the HR image in combination with the residual feature and the input image, thereby accelerating the training speed and the convergence speed of the network. In addition, compared with multiple state-of-the-art relevant methods, the present disclosure yields the best reconstruction effect qualitatively and quantitatively.

The present disclosure provides a novel method for solving the SR reconstruction problem. An SR convolutional neural network, named as the SRMCSC network and as shown in FIG. 1, is constructed in combination with the ML-CSC and the deep learning.

In FIG. 1, each constituent part in the network of the present disclosure is designed to implement a special task. The present disclosure constructs a three-layer LISTA containing a dilated convolution to recognize and separate the residual, and then reconstructs a residual image with a sparse feature mapping γ_{S}^{K} obtained from the three-layer LISTA, and finally, obtains an HR output image in combination with the residual and the input image. The bottom of FIG. 1 shows the internal structure in each iteration update, and there are 11 layers in each iteration. In the figure, “Cony” represents convolution, “TransConv” represents a transpose of the convolution, and “Relu” represents an activation function.

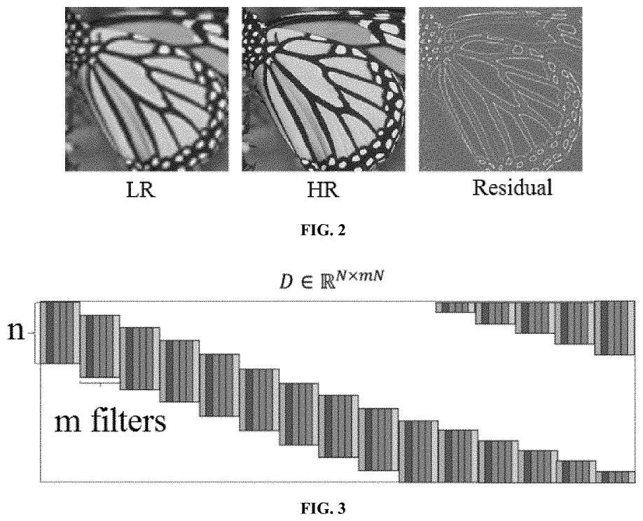

FIG. 2 illustrates a difference between an LR image and an HR image, where the LR image, the HR image and the residual image are showing.

The network structure mainly includes the iterative algorithm for solving regularized optimization of multi-layer sparsity, namely ML-LISTA, and the residual learning. The present disclosure mainly use the residual learning, since the LR image and the HR image are similar to a great extent, with the difference as shown by Residual in FIG. 2. In the case where the input and the output are highly associated, the display of the residual image during modeling is an effective learning method to accelerate the training. The use of the ML-CSC is mainly ascribed to the following two reasons. First, the LR image and the HR image are basically similar, with the difference as shown by Residual in FIG. 2. The present disclosure defines the difference as the residual image U=x−y, and in the image, most values are zero or less, thus the residual image exhibits the obvious sparsity. Moreover, the ML-CSC model is applied to reconstructing an object with the obvious sparsity, because the multi-layer structure of such model can constrain the sparsity of the sparse representation of the deepest layer and make the sparse representation of the shallow layer more sparse. Second, the multi-layer model makes the network structure deeper and more stable, thereby expanding context information of the image region, and solving the problem that information in the small patch is insufficient to restore the details.

Therefore, the proposed SRMCSC is the interpretable end-to-end supervised neural network inspired from the ML-CSC model; and the network is a recursive network architecture having skip connections, is useful for the SR image reconstruction, and contains network layers strictly corresponding to each step in the processing flow of the unfolding three-layer ML-LISTA model. More specifically, the soft thresholding function in the algorithm is replaced by the ReLU activation function, and all parameters and filter weights in the network are updated by minimizing a loss function with BP. Different from the SRCNN, on one hand, the present disclosure can initialize the parameters in the SRMCSC with a more principled method upon a correct understanding of the physical significance of each layer, which is helpful to improve the optimization speed and quality. On the other hand, the network is data-driven, and is a novel interpretable network designed in combination with neighborhood knowledge and deep learning. The SRMCSC method proposed by the present disclosure and four typical SR methods are all subjected to benchmark testing on the test sets Set5, Set14 and BSD100. Compared with the typical SR methods, including Bicubic interpolation, sparse coding presented by Zeyde et al., local linear neighborhood embedding (NE+LLE), and anchored neighborhood regression (ANR),, the method of the present disclosure exhibits an obvious average PSNR gain of about 1-2 dB under all scale factors. Compared with the deep learning method which is the SRCNN, the method of the present disclosure exhibits an obvious average PSNR gain of about 0.4-1 dB under all scale factors; and particularly, when the scale factor is 2, the average PSNR value of the method on the test set Set5 is 1 dB higher than that of the SRCNN. Therefore, the method of the present disclosure is more accurate and effective than other methods.

To sum up, the work of the present disclosure is summarized as follows:

(1) The present disclosure provides the interpretable end-to-end CNN for the SR reconstruction, namely the SRMCSC network, with the architecture inspired from the processing flow of the unfolding three-layer ML-LISTA model. The network gets deeper by increasing the number of iterations without introducing additional parameters.

(2) With the residual learning, the method of the present disclosure accelerates the convergence speed in the deep network training to improve the learning efficiency.

(3) Compared with multiple state-of-the-art relevant methods, the present disclosure yields the best reconstruction effect qualitatively and quantitatively and is less time-consuming.

### 2. ML-CSC

The present disclosure describes the ML-CSC model from the SC. The SC has been widely applied in image processing. Particularly, steady progresses have been made by the sparse model for a long time in the SR reconstruction field. The SC aims to find a sparsest representation γ∈R^{M} of a signal y ∈R^{N} in a given overcomplete dictionary A∈R^{N×M} (M>N), namely y=Aγ; and a γ problem which is also called a Lasso or [symbol] ₁-regularization BP problem is solved:

$${min}_{γ} \frac{1}{2} {‖ y - A γ ‖}_{2}^{2} + α {‖ γ ‖}_{1} \qquad ( 1 )$$

where, a constant α is used to weigh a reconstruction item and a regularization item. The problem can be solved by various classical methods such as orthogonal matching pursuit (OMP) and basis pursuit (BP), and particularly the ISTA is a prevalent and effective method to solve the problem (1). An update equation of the ISTA may be written as:

$$\begin{matrix}{γ}^{i + 1} = {S}_{\frac{α}{L}} ( {γ}^{i} - \frac{1}{L} ( - {A}^{T} y + {A}^{T} A {γ}^{i} ) ) \\ = {S}_{\frac{α}{L}} ( \frac{1}{L} {A}^{T} y + ( I - \frac{1}{L} {A}^{T} A ) {γ}^{i} )\end{matrix} \qquad ( 2 )$$

where, γⁱ represents an ith iteration update, L is a Lipschitz constant, and Sp(·)is a soft thresholding operator with a threshold ρ. The soft thresholding operator is defined as follows:

$${S}_{ρ} ( z ) = \{ \begin{matrix}z + ρ , & z < - ρ \\ 0 , & - ρ \leq z \leq ρ \\ z - ρ , & z > ρ\end{matrix} .$$

In order to improve the timeliness of the ISTA, the “learning version” of the ISTA, namely the learned iterative soft thresholding algorithm (LISTA), is proposed. The LISTA is configured to be approximate to the SC of the ISTA through learning parameters from data. However, most SC-based methods are implemented by segmenting the whole image into overlapping blocks to relieve the modeling and calculation burdens. These methods ignore the consistency between the overlapping blocks to cause the difference between the global image and the local image. In view of this, a convolutional sparse coding (CSC) model is proposed to perform the SC on a whole image, where the image may be obtained by performing convolution on m local filters dᵢ∈Rⁿ(n<<N) and corresponding feature maps γi∈R^{N} thereof and linearly combining the convolution results, namely

$$x = {\sum }_{i = 1}^{m} {d}_{i} * {γ}_{i} ;$$

and corresponding to equation (1), an optimization problem of the CSC model may be written as:

$${min}_{{γ}_{i}} \frac{1}{2} {‖ y - {\sum }_{i = 1}^{m} {d}_{i} * {γ}_{i} ‖}_{2}^{2} + α {‖ {\sum }_{i = 1}^{m} {γ}_{i} ‖}_{1} . \qquad ( 3 )$$

Although solutions for equation (3) have been proposed, the convolution operation may be executed as matrix multiplication, and is implemented by converting the filters into a banded circulant matrix to construct a special convolutional dictionary D∈R^{N×mN}, namely x=Dγ. As shown in FIG. 3, various small block of the convolutional dictionary D serve as local dictionaries, and all have the same size of nxm elements, with the filters {dᵢ}ᵢ₌₁^{m} as columns. Hence, the CSC model (3) may be viewed as a special form of an SC model (1). Specifically, the matrix multiplication (2) of the ISTA is replaced by the convolution operation. Similarly, the LISTA may also solve the CSC problem (3).

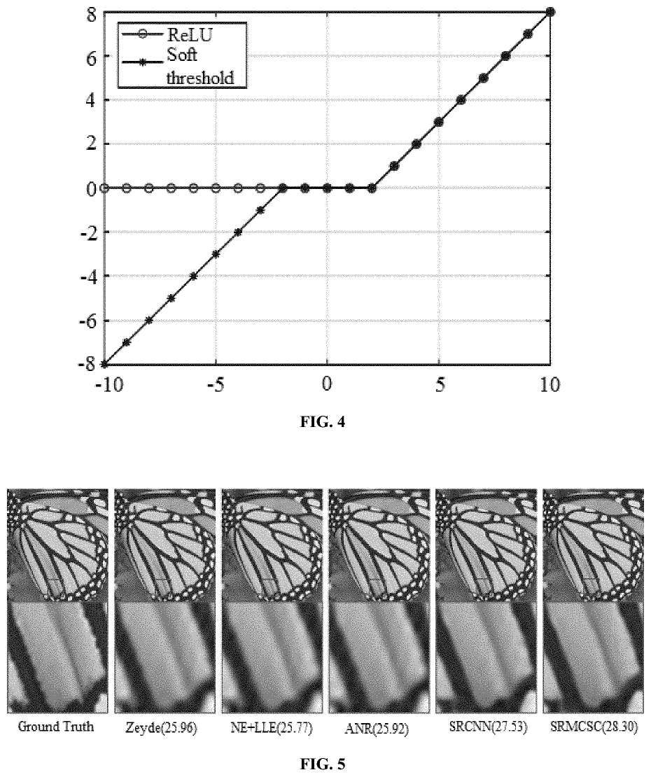

In some work, it is proposed that the calculation efficiency of the CSC is effectively improved in combination with the calculation ability of the CNN, to allow the model to be more adaptive. The thresholding operator is a basis for a CNN and a CSC model; by comparing an ReLU in the CNN with a soft thresholding function, the ReLU and the soft thresholding function keep consistent in a non-negative part, as shown in FIG. 4, from which a non-negative CSC model is conceived, corresponding optimization problem (1) needs to be added with a constraint to make a result positive, namely:

$${min}_{γ} \frac{1}{2} {‖ y - D γ ‖}_{2}^{2} + α {‖ γ ‖}_{1} s . t . γ \geq 0. \qquad ( 4 )$$

Naturally, a resulting problem is whether the constraint affects an expressive ability of an original sparse model. As a matter of fact, there is no doubt that because a negative coefficient of the original sparse model may be transferred to a dictionary, for a given a signal y=Dγ, the signal may be written as:

y=Dγ₊+(−D) (5)

where, γ may be divided into γ+ and γ−, γ+ includes a positive element, γ− includes a negative element, and both the γ+ and the −γ− are non-negative. Apparently, a non-negative sparse representation [γ+−γ−]^{T} is allowable for the signal y in a dictionary [D-D]. Therefore, each SC may be converted into non-negative SC (NNSC), and the NNSC problem (4) may also be solved by the soft thresholding algorithm. In the present disclosure, a non-negative soft thresholding operator Sρ⁺may be defined as:

$${S}_{ρ}^{+} ( z ) = \{ \begin{matrix}0 , & z \leq ρ \\ z - ρ , & z > ρ\end{matrix} .$$

Meanwhile, it is assumed that γ⁰=0, thus an iterative update of γ in the problem (4) may be written as:

$${γ}^{1} = {S}_{\frac{α}{L}}^{+} ( \frac{1}{L} ( {D}^{T} y ) ) \qquad ( 6 )$$

In combination with the activation function ReLU in the typical CNN, the non-negative soft thresholding operator is apparently equivalent to an ReLU function:

S_{ρ}⁺(z)=max(z−ρ, 0)=ReLU(z−ρ) (7)

Therefore, equation (6) is equivalently written as:

$$\begin{matrix}{γ}^{1} = {S}_{\frac{α}{L}}^{+} ( \frac{1}{L} ( {D}^{T} y ) ) \\ = ReLU ( Wy - b )\end{matrix} \qquad ( 8 )$$

where, a bias vector b corresponds to a threshold

$$\frac{α}{L} ;$$

and in other words, α is a hyper-parameter in the SC, but a learning parameter in the CNN. Furthermore, dictionary learning may be completed through D=W^{T}. Therefore, the non-negative soft thresholding operator for the CSC model is closely associated with the CNN.

In recent years, with the inspiration that the double sparse performance accelerates the training process, the ML-CSC model has been proposed. It is assumed that the convolutional dictionary D may be decomposed into multiplication of multiple matrices, namely x=D₁D₂ . . . D_{LγL}. The ML-CSC model may be described as:

$$x = {D}_{1} {γ}_{1}$$

$${γ}_{1} = {D}_{2} {γ}_{2}$$

$${γ}_{2} = {D}_{3} {γ}_{3}$$

$$…$$

$${γ}_{L - 1} = {D}_{L} {γ}_{L} .$$

where, γᵢ is a sparse representation of an ith layer and also a signal of an (i+l)th layer, and Dᵢ, is a convolutional dictionary of the ith layer and a transpose of a convolutional matrix. An effective dictionary {Dᵢ}ᵢ₌₁^{L} serves as an analysis operator, to making a sparse representation of a shallow layer less sparse. Consequently, different representation layers are used in an analysis-based prior and a synthesis-based prior, such that prior information may not only constrain a sparsity of a sparse representation of a deepest layer, but also make the sparse representation of the shallow layer less sparse. The ML-CSC is also a special form of an SC(1) model. Therefore, for a given signal (such as an image), it is assumed that γₒ=y′, an optimization object of the ith layer in the ML-CSC model may be written as:

$${min}_{{γ}_{i}} \frac{1}{2} {‖ {γ}_{i - 1} - {D}_{i} {γ}_{i} ‖}_{2}^{2} + {α}_{i} {‖ {γ}_{i} ‖}_{1} , \qquad ( 9 )$$

where, αᵢ is a regularization parameter of the ith layer. Similar to equation (2), an ISTA may be used to obtain an update of γₗ in the problem (9). The algorithm is repeated to obtain an ML-ISTA of {γᵢ}ᵢ₌₁^{L}, and it is proved that the ML-ISTA converges at a rate of

$$O ( \frac{1}{k} )$$

to a globally optimal solution of the ML-CSC. With the inspiration from the LISTA, the ML-LISTA, as described by the algorithm 1, is proposed.

Algorithm 1 multi-Layer LISTA(ML-LISTA)

```
  Input: signal y, convolutional dictionary {Bᵢ} [symbol] {Wᵢ}
  Threshold {pᵢ}
Thresholding operator P ϵ {S, S⁺}
    Output: Sparse vector { [symbol] }
        Initialize: set [symbol]  = y, ∀k [symbol]  = 0
      1. for k = 1 : K do
      2. [symbol]  ← W(i,L) γ_{L}^{k} ∀ᵢ ϵ [0, L -1]
      3, for i = 1 : L do
      4. γᵢ^{k+1} ← Pₚᵢ((I - Wᵢ^{T}Wᵢ) + Bᵢ^{T} γᵢ₋₁^{k+1}) [symbol]
indicates data missing or illegible when filed
```

Where, (I−Wᵢ^{T}Wᵢ)\hat{γ}ᵢ+Bᵢ^{T}γᵢ₋₁^{k+1} replaces an iterative operator

$$( I - \frac{1}{{L}_{i}} {D}_{i}^{T} {D}_{i} ) \hat{{γ}_{i}} + \frac{1}{{L}_{i}} {D}_{i}^{T} {γ}_{i - 1}^{k + 1} ;$$

a dictionary Dᵢ in the ML-LISTA is decomposed into two dictionaries Wᵢ and Bᵢ with a same size, and each of the dictionaries Wᵢ and Bᵢ is also constrained as a convolutional dictionary to control a number of parameters. An interesting point is that if a deepest sparse representation with an initial condition of γ_{L}¹=0 is found through only one iteration, the representation can be rewritten as:

γL=P_{ρL}((B_{L}^{T}P_{ρL-1}( . . . P_{ρ1}(B₁^{T}y)))) (10)

Further, if a non-negative assumption similar to equation (4) is made to a sparse representation coefficient, a thresholding operator P is a non-negative projection. A process of obtaining a deepest sparse representation is equivalent to that of obtaining a stable solution of a neural network, namely forwarding propagation of the CNN may be understood as a tracing algorithm for obtaining a sparse representation with a given input signal (such as an image). In other words, a dictionary Di in the ML-CSC model is embedded into a learnable convolution kernel of each of the Wᵢ and the Bᵢ, that is a dictionary atom (a column in the dictionary) in Bᵢ^{T}(or Wᵢ^{T}) represents a convolutional filter in the CNN. In order to make a full use of the advantages of the deep learning, each of the Wᵢ and the Bᵢ is modeled with an independent convolutional kernel. A threshold ρᵢ is parallel to a bias vector bᵢ, and a non-negative soft thresholding operator is equivalent to an activation function ReLU of the CNN. However, as the number of iterations increases, the situation becomes more complicated, and the unfolding ML-LISTA algorithm will result in a recursive neural network having skip connections. Therefore, how to develop the network of the present disclosure on the basis of the ML-CSC model and convert the network into a network for the SR reconstruction will be described in the next section.

3. SRMCSC Network

The present disclosure illustrates the framework of the proposed SRMCSC network in FIG. 1. The framework is mainly inspired from the unfolding three-layer LISTA. The network includes two parts: an ML-LISTA feature extraction part and an HR image reconstruction part. The whole network is an end-to-end system, with an LR image y as an input, and a directly generated and real HR image x as an output. A depth of the network is only related to a number of iterations. As can be seen, these recursive components and connections follow accurate and reasonable optimization, which provides a certain theoretical support for the SRMCSC network.

3.1 Network Structure

The network architecture proposed by the present disclosure for the SR reconstruction is inspired from the unfolding ML-LISTA. It is empirically noted by the present disclosure that a three-layer model is sufficient to solve the problem of the present disclosure. Each layer and each skip connection in the SRMCSC network strictly correspond to each step of a processing flow of a three-layer LISTA, an algorithm framework is unfolded to serve as a first constituent part of the SRMCSC network, as shown in FIG. 1, and first three layers of the network correspond to a first iteration of the algorithm. A middle hidden layer for iterative update in the network includes update blocks, with the structure corresponding to the bottom diagram in FIG. 1. Therefore, the proposed network of the present disclosure may be interpreted as an approximate algorithm for solving a multi-layer BP problem. In addition, a sparse feature mapping γ_{S}^{K} is obtained through K iterations. A residual image is estimated according to a definition of the ML-CSC model and in combination with the sparse feature mapping and a dictionary, an estimated residual image U mainly including high frequent detail information, and a final HR image x is obtained through equation (11) to serve as a second constituent part of the network.

x=U+y (11)

Performance of the network only depends on an initial value of a parameter, a number K of iterations and a number of filters. In other words, the network only needs to increase the number of iterations but not introduce an additional parameter, and parameters of the filters to be trained by the model only include three dictionaries with a same size. In addition, it is to be noted that, different from other empirical networks, each of the skillful skip connections in the network can be theoretically explained.

3.2 Loss Function

MSE is the most common loss function in image applications. The MSE is still used in the present disclosure. N training pairs {yᵢ, xᵢ}ᵢ₌₁^{N}, namely LR-HR patch pairs, are given to minimize a following objective function:

$$L ( Θ ) = {\sum }_{i = 1}^{N} {‖ f ( {y}_{i} ; Θ ) - {x}_{i} ‖}_{F}^{2} .$$

where, ƒ(·) is the SRMCSC network of the present disclosure, Θ represents all trainable parameters, and an Adam optimization program is used to optimize the parameters of the network

TABLE 1
Comparisons of different model configurations in term of
PSNR(dB)/time(s) value on dataset Set5 (scale factor ×2)

| | filters = 32 | filters = 64 | filters = 128 |
|---|---|---|---|
| K = 2 | 36.73/0.41 | 36.86/0.87 | 36.90/1.92 |
| K = 3 | 36.74/0.42 | 36.88/0.87 | 36.90/1.92 |
| K = 4 | 36.76/0.41 | 36.87/0.87 | 36.91/1.92 |
| Params | 0.38 × 10⁵ | 1.5 × 10⁵ | 5.9 × 10⁵ |

4. Experiments and Results

4.1 Datasets

The present disclosure takes 91 common images in SR reconstruction literatures as a training set. All models of the present disclosure are learned from the training set. In view of limitations of a memory of the graphics processing unit (GPU), sub-images for training have a size of 33. Therefore, the dataset including the 91 images can be decomposed into 24,800 sub-images, and these sub-images are extracted from the original image at a step size of 14. The benchmark testing is performed on datasets Set5, S et14 and BSD100.

4.2 Parameter Settings

During work of the present disclosure, the present disclosure uses an Adam solver having a minimum batch size of 16; and for other hyper-parameters of the Adam, the present disclosure uses default settings. The learning rate of the Adam is fixed at 10⁻⁴, the epoch is set as 100 and is far less than that of the SRCNN, and training one SRMCSC network takes about an hour and a half. All tests of the model in the present disclosure are conducted in the pytorch environment python3.7.6, which is run on the personal computer (PC) that is provided with the Intel Xeon E5-2678 V3 central processing unit (CPU) and the Nvidia RTX 2080Ti GPU. Each of the convolutional kernels has a size of 3×3, the number of filters on each layer is the same. Now, how to set the number of filters and the number of iterations is described below.

4.2.1 Settings the Number of Filters and the Number of Iterations

The present disclosure is to investigate influences of different model configurations on performance of the network. As the network structure of the present disclosure is inspired from the unfolding three-layer LISTA, the present disclosure can improve the performance by adjusting the number R of filters and the number K of iterations on each layer. It is to be noted that the number of filters on each layer is the same in the present disclosure. In addition, it is to be noted that, the network can get deeper by increasing the number of iterations without introducing additional parameters. The present disclosure tests different combinations of the number of filters and the number of iterations on the dataset Set5 under the scale factor ×2, and makes comparisons in the SR reconstruction performance. Specifically, the testing is performed under a condition where the number of filters is R∈{32, 64, 128, 256}, and the number of iterations is K∈11, 2, 31. With results as shown in Table 1, when the number of iterations is the same, and the number of filters is increased from 32 to 128, the PSNR is increased more obviously. In order to equilibrate the effectiveness and the efficiency, the present disclosure selects R=64 and K=3 as default settings.

4.3 Comparisons with State-of-the-Art Methods

In the present disclosure, in order to evaluate the SR image reconstruction performance of the SRMCSC network, the method of the present disclosure is qualitatively and quantitatively compared with four state-of-the-art SR methods, including Bicubic interpolation, SC presented by Zeyde et al., NE+LLE, ANR and SRCNN. Average results of all comparative methods on three test sets are as shown in Table 2, and the best result is boldfaced. The results indicate that the SRMCSC network is superior to other SR methods in term of PSNR value on all test sets and under all scale factors. Specifically, compared with the classical SR methods, including Bicubic interpolation, SC presented by Zeyde et al., NE+LLE, and ANR, the method of the present disclosure exhibits an obvious average PSNR gain of about 1-2 dB under all scale factors. Compared with the deep learning method which is the SRCNN, the method of the present disclosure exhibits an average PSNR gain of about 0.4-1 dB under all scale factors. Particularly, when the scale factor is 2, the average PSNR value of the method on the Set5 is 1 dB higher than that of the SRCNN.

TABLE 2
Average PSNR (dB) results on datasets Set5, Set14
and B100 under scale factors 2, 3 and 4, with
the boldface indicating the best performance

| | | Bi- | | NE + | | | SRMCSC |
|---|---|---|---|---|---|---|---|
| Dataset | Scale | cubic | Zeyde | LLE | ANR | SRCNN | (Ours) |
| Set5 | ×2 | 33.66 | 35.78 | 35.78 | 35.83 | 36.34 | 36.88 |
| | ×3 | 30.39 | 31.90 | 31.84 | 31.92 | 32.39 | 33.41 |
| | ×4 | 28.42 | 29.69 | 29.61 | 29.69 | 30.09 | 30.44 |
| Set14 | ×2 | 30.24 | 31.81 | 31.76 | 31.80 | 32.18 | 32.51 |
| | ×3 | 27.55 | 28.67 | 28.60 | 28.65 | 29.00 | 29.25 |
| | ×4 | 26.00 | 26.88 | 26.81 | 26.85 | 27.20 | 27.43 |
| BSD100 | ×2 | 29.56 | 30.40 | 30.41 | 30.44 | 30.71 | 31.38 |
| | ×3 | 27.21 | 27.87 | 27.87 | 27.89 | 28.10 | 28.39 |
| | ×4 | 25.96 | 26.51 | 26.47 | 26.51 | 26.66 | 26.87 |

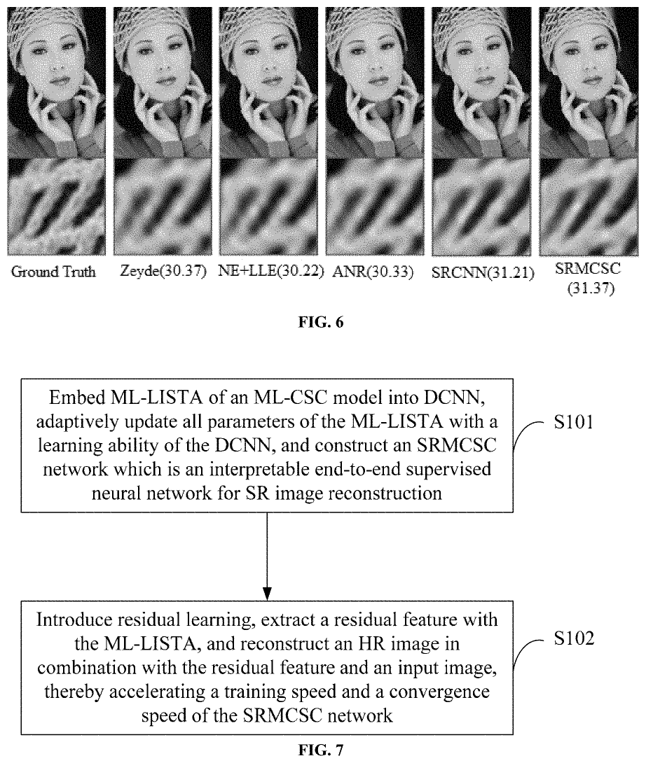

The table shows the comparisons of the method of the present disclosure with other methods. FIG. 5 and FIG. 6 respectively corresponding to “butterfly” and “woman” on Set5 provide the comparisons in visual quality. As can be seen from FIG. 5, the method (SRMCSC) of the present disclosure has the higher PSNR values than other methods. For example, by amplifying the image to the rectangular region below the image, only the method of the present disclosure perfectly reconstructs the middle straight line in the image. Similarly, by comparing amplified parts in gray boxes in FIG. 6, the method of the present disclosure exhibits the clearest contour, while other methods exhibit the severely blurred or distorted contours.

The present disclosure proposes a novel SR deep learning method, namely, the interpretable end-to-end supervised convolutional network (SRMCSC network) is established in combination with the MI-LISTA and the DCNN, for the SR reconstruction. Meanwhile, with the interpretability, the present disclosure can better design the network architecture to improve the performance, rather than simply stack network layers. In addition, the present disclosure introduces the residual learning to the network, thereby accelerating the training speed and the convergence speed of the network. The network can get deeper by directly changing the number of iterations, without introducing additional parameters. Experimental results indicate that the SRMCSC network can generate visually attractive results to offer a practical solution for the SR reconstruction.

The above embodiments may be implemented completely or partially by using software, hardware, firmware, or any combination thereof When the above embodiments are implemented in the form of a computer program product in whole or part, the computer program product includes one or more computer instructions. When the computer program instructions are loaded and executed on a computer, the procedures or functions according to the embodiments of the present disclosure are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital video disc (DVD), a semiconductor medium (for example, a solid state disk (SSD)), or the like.

The foregoing are merely descriptions of the specific embodiments of the present disclosure, and the protection scope of the present disclosure is not limited thereto. Any modification, equivalent replacement, improvement and the like made within the technical scope of the present disclosure by a person skilled in the art according to the spirit and principle of the present disclosure shall fall within the protection scope of the present disclosure.

What is claimed is:

1. A super-resolution (SR) image reconstruction method based on deep convolutional sparse coding (DCSC), comprising following steps:
embedding multi-layer learned iterative soft thresholding algorithm (ML-LISTA) of a multi-layer convolutional sparse coding (ML-CSC) model into deep convolutional neural network (DCNN), adaptively updating all parameters of the ML-LISTA with a learning ability of the DCNN, and constructing an SR multi-layer convolutional sparse coding (SRMCSC) network which is an interpretable end-to-end supervised neural network for SR image reconstruction; and
introducing residual learning, extracting a residual feature with the ML-LISTA, and reconstructing a high-resolution (HR) image in combination with the residual feature and an input image, thereby accelerating a training speed and a convergence speed of the SRMCSC network.

2. The SR image reconstruction method based on DCSC according to claim 1, wherein in the constructing the ML-CSC model, sparse coding (SC) is implemented to find a sparsest representation γ∈R^{M} of a signal y∈R^{N} in a given overcomplete dictionary A∈R^{N×M} (M>N), which is expressed as y=Aγ; and a γ problem which is also called a Lasso or [symbol] 1-regularization backpropagation (BP) problem is solved:
$${min}_{γ} \frac{1}{2} {‖ y - A γ ‖}_{2}^{2} + α {‖ γ ‖}_{1} \qquad ( 1 )$$
wherein, a constant α is used to weigh a reconstruction item and a regularization item; and an update equation of an iterative soft thresholding algorithm (ISTA) is written as:
$${γ}^{i + 1} = {S}_{\frac{α}{L}} ( {γ}^{i} - \frac{1}{L} ( - {A}^{T} y + {A}^{T} A {γ}^{i} ) ) = {S}_{\frac{α}{L}} ( \frac{1}{L} {A}^{T} y + ( I - \frac{1}{L} {A}^{T} A ) {γ}^{i} ) \qquad ( 2 )$$
wherein, γⁱ represents an ith iteration update, L is a Lipschitz constant, and Sρ(·)is a soft thresholding operator with a threshold ρ; and the soft thresholding operator is defined as follows:
$${S}_{ρ} ( z ) = \{ \begin{matrix}z + ρ , & z < - ρ \\ 0 , & - ρ \leq z \leq ρ \\ z - ρ , & z > ρ\end{matrix} .$$

3. The SR image reconstruction method based on DCSC according to claim 1, wherein constructing the ML-CSC model comprises: proposing a convolutional sparse coding (CSC) model to perform SC on a whole image, wherein the image is obtained by performing convolution on m local filters dᵢ∈Rⁿ(n<<N) and corresponding feature maps γᵢ∈R^{N} thereof and linearly combining resultant convolution results, which is expressed as
$$x = {\sum }_{i = 1}^{m} {d}_{i} * {γ}_{i} ;$$
and corresponding to equation (1), an optimization problem of the CSC model is written as:
$${min}_{{γ}_{i}} \frac{1}{2} {‖ y - {\sum }_{i = 1}^{m} {d}_{i} * {γ}_{i} ‖}_{2}^{2} + α {‖ {\sum }_{i = 1}^{m} {γ}_{i} ‖}_{1} ; \qquad ( 3 )$$
and
converting the filters into a banded circulant matrix to construct a special convolutional dictionary D∈R^{N×mN}, thereby x=Dγ, wherein in the convolutional dictionary D, all small blocks each serve as a local dictionary, and have a same size of nxm elements, with filters {dᵢ}ᵢ₌₁^{m} as respective columns; the CSC model (3) is considered as a special form of an SC model (1), matrix multiplication in equation (2) of the ISTA is replaced by a convolution operation, and the CSC problem (3) are also solved by the LISTA.

4. The SR image reconstruction method based on DCSC according to claim 1, wherein constructing the ML-CSC model further comprises: proposing a relationship between a convolutional neural network (CNN) and a CSC model, wherein a thresholding operator is a basis of the CNN and the CSC model; by comparing a rectified linear unit (ReLU) in the CNN with a soft thresholding function, the ReLU and the soft thresholding function keep consistent in a non-negative part; and for a non-negative CSC model, a corresponding optimization problem (1) is added with a constraint to allow a result to be positive:
$${min}_{γ} \frac{1}{2} {‖ y - D γ ‖}_{2}^{2} + α {‖ γ ‖}_{1} s . t . γ \geq 0. \qquad ( 4 )$$
and for a given signal y=Dγ, the signal is written as:
y=Dγ₊+(−D)(−γ₋) (5)
wherein, γ is divided into γ+ and γ−, γ+ comprises a positive element, γ− comprises a negative element, and both the γ+ and the −γ− are non-negative; a non-negative sparse representation [γ+ −γ−]^{T} is allowable for the signal y in a dictionary [D D]; and each SC is converted into non-negative SC (NNSC), and the NNSC problem (4) is also solved by the soft thresholding algorithm; and a non-negative soft thresholding operator Sρ⁺ is defined as:
$${S}_{p}^{+} ( z ) = \{ \begin{matrix}0 , & z \leq ρ \\ z - ρ , & z > ρ .\end{matrix}$$
assuming that γ⁰=0, an iteration update of γ in the problem (4) is written as:
$${γ}^{1} = {S}_{\frac{α}{L}}^{+} ( \frac{1}{L} ( {D}^{T} y ) ) \qquad ( 6 )$$
the non-negative soft thresholding operator is equivalent to an ReLU function:
S_{ρ}⁺(z)=max(z−ρ,0)=ReLU(z−ρ) (7)
the equation (6) is equivalently written as:
$$\begin{matrix}{γ}^{1} = {S}_{\frac{α}{L}}^{+} ( \frac{1}{L} ( {D}^{T} y ) ) \\ = Re LU ( Wy - b )\end{matrix} \qquad ( 8 )$$
wherein, a bias vector b corresponds to a threshold
$$\frac{α}{L} ,$$
and α is a hyper-parameter in the SC, but a learning parameter in the CNN; dictionary learning is completed through D=W^{T}; and the non-negative soft thresholding operator for the CSC model is closely associated with the CNN.

5. The SR image reconstruction method based on DCSC according to claim 1, wherein constructing the ML-CSC model further comprises: proposing the ML-CSC model, wherein a convolutional dictionary D is decomposed into multiplication of multiple matrices, x=D₁D₂ . . . D_{LγL}, and describing the ML-CSC model as:
$$x = {D}_{1} {γ}_{1}$$
$${γ}_{1} = {D}_{2} {γ}_{2}$$
$${γ}_{2} = {D}_{3} {γ}_{3}$$
$$…$$
$${γ}_{L - 1} = {D}_{L} {γ}_{L} .$$
wherein, γᵢ is a sparse representation of an ith layer and also a signal of an (i+1)th layer, and Dᵢ, is a convolutional dictionary of the ith layer and a transpose of a convolutional matrix; an effective dictionary {Dᵢ}ᵢ₌₁^{L} serves as an analysis operator for causing a sparse representation of a shallow layer to be less sparse; different representation layers are used in an analysis-based prior and a synthesis-based prior, such that prior information not only constrains a sparsity of a sparse representation of a deepest layer, but also allows the sparse representation of the shallow layer to be less sparse; the ML-CSC is also a special form of an SC(1) model; and for a given signal γ₀=y, an optimization object of the ith layer in the ML-CSC model is written as:
$${min}_{{γ}_{i}} \frac{1}{2} {‖ {γ}_{i - 1} - {D}_{i} {γ}_{i} ‖}_{2}^{2} + {α}_{i} {‖ {γ}_{1} ‖}_{1} \qquad ( 9 )$$
wherein, αᵢ, is a regularization parameter of the ith layer; similar to equation (2), the ISTA is used to obtain an update of γₗ in the problem (9); the ISTA is repeated to obtain an ML-ISTA of {γᵢ}ᵢ₌₁^{L}, and the ML-ISTA converges at a rate of
$$O ( \frac{1}{k} )$$
to a globally optimal solution of the ML-CSC.

6. The SR image reconstruction method based on DCSC according to claim 1, wherein constructing the ML-CSC model further comprises: proposing the ML-LISTA which is configured to be approximate to a SC of the ML-ISTA through learning parameters from data, wherein, (I−Wᵢ^{T}Wᵢ)\hat{γ}ᵢ+Bᵢ^{T}γᵢ₋₁^{k+1} replaces an iterative operator
$$( I - \frac{1}{{L}_{i}} {D}_{i}^{T} {D}_{i} ) {\hat{γ}}_{i} + \frac{1}{{L}_{i}} {D}_{i}^{T} {γ}_{i - 1}^{k + 1} ;$$
a dictionary Dᵢ in the ML-LISTA is decomposed into two dictionaries Wᵢ, and Bᵢ with a same size, and each of the dictionaries Wᵢ, and Bᵢ is also constrained as a convolutional dictionary to control a number of parameters; and if a deepest sparse representation with an initial condition of γ_{L}¹=0 is found through only one iteration, the representation is rewritten as:
γL=P_{ρL}((B_{L}^{T}P_{ρL-1}( . . . P_{ρ1}(B₁^{T}y)))) (10).

7. The SR image reconstruction method based on DCSC according to claim 1, wherein if a non-negative assumption similar to equation (4) is made to a sparse representation coefficient, a thresholding operator P is a non-negative projection; a process of obtaining a deepest sparse representation is equivalent to that of obtaining a stable solution of a neural network, namely forwarding propagation of the CNN is a tracing algorithm for obtaining a sparse representation with a given input signal; a dictionary Di in the ML-CSC model is embedded into a learnable convolution kernel of each of Wi and Bi, a dictionary atom in Bᵢ^{T} (or Wᵢ^{T}) represents a convolutional filter in the CNN, and each of the Wi and the Bi is modeled with an independent convolutional kernel; and a threshold ρᵢ is parallel to a bias vector bᵢ, and a non-negative soft thresholding operator is equivalent to an activation function ReLU of the CNN.

8. The SR image reconstruction method based on DCSC according to claim 1, wherein the SRMCSC network comprises two parts: an ML-LISTA feature extraction part and an HR image reconstruction part; the network is an end-to-end system, with a low-resolution (LR) image y as an input, and a directly generated and real HR image x as an output; and a depth of the network is only related to a number of iterations;
each layer and each skip connection in the SRMCSC network strictly correspond to each step of a processing flow of a three-layer LISTA, an unfolded algorithm framework of the three-layer LISTA serves as a first constituent part of the SRMCSC network, and first three layers of the network correspond to a first iteration of the algorithm; a middle hidden layer having an iterative update in the network comprises update blocks; a sparse feature mapping γ3^{K} is obtained through K iterations; and a residual image is estimated according to a definition of the ML-CSC model and in combination with the sparse feature mapping and a dictionary, an estimated residual image U mainly comprising highly frequent detail information, and a final HR image xis obtained through equation (11) to serve as a second constituent part of the network;
x=U+y (11)
performance of the network only depends on an initial value of a parameter, a number of iterations K and a number of filters; and in other words, thereof the network only increases the number of iterations without introducing an additional parameter, and parameters of the filters to be trained by the model only comprise three dictionaries with a same size; and
a loss function that is a mean squared error (MSE) is used in the SRMCSC network: N training pairs {yᵢ, xᵢ}ᵢ₌₁^{N}, namely LR-HR patch pairs, is given to minimize a following objective function:
$$L ( Θ ) = {\sum }_{i = 1}^{N} {‖ f ( {y}_{i} ; Θ ) - {x}_{i} ‖}_{F}^{2} ;$$
wherein, ƒ(·) is the SRMCSC network, Θ represents all trainable parameters, and an Adam optimization program is used to optimize the parameters of the network.

9. A computer program product stored on a non-transitory computer readable storage medium, comprising a computer readable program, configured to provide, when executed on an electronic device, a user input interface to implement the SR image reconstruction method based on DCSC according to claim 1, the method comprising following steps:
embedding ML-LISTA of a ML-CSC model into DCNN, adaptively updating all parameters of the ML-LISTA with a learning ability of the DCNN, and constructing an SRMCSC network which is an interpretable end-to-end supervised neural network for SR image reconstruction; and
introducing residual learning, extracting a residual feature with the ML-LISTA, and reconstructing a HR image in combination with the residual feature and an input image, thereby accelerating a training speed and a convergence speed of the SRMCSC network.

10. The computer program product stored on a non-transitory computer readable storage medium according to claim 9, wherein in the constructing the ML-CSC model, SC is implemented to find a sparsest representation γ∈R^{M} of a signal γ∈R^{N} in a given overcomplete dictionary A∈R^{N×M}(M>N), which is expressed as y=Aγ; and a γ problem which is also called a Lasso or [symbol] 1-regularization BP problem is solved:
$${min}_{γ} \frac{1}{2} {‖ y - A γ ‖}_{2}^{2} + α {‖ γ ‖}_{1} \qquad ( 1 )$$
wherein, a constant α is used to weigh a reconstruction item and a regularization item; and an update equation of an ISTA is written as:
$$\begin{matrix}{γ}^{i + 1} = {S}_{\frac{α}{L}} ( {γ}^{i} - \frac{1}{L} ( - {A}^{T} y + {A}^{T} A {γ}^{i} ) ) \\ = {S}_{\frac{α}{L}} ( \frac{1}{L} {A}_{T} y + ( I - \frac{1}{L} {A}^{T} A ) {γ}^{i} )\end{matrix} \qquad ( 2 )$$
wherein, γⁱ represents an ith iteration update, L is a Lipschitz constant, and Sρ(·)is a soft thresholding operator with a threshold ρ; and the soft thresholding operator is defined as follows:
$${S}_{ρ} ( z ) = \{ \begin{matrix}z + ρ , & z < - ρ \\ 0 , & - ρ \leq z \leq ρ \\ z - ρ , & z > ρ\end{matrix} .$$

11. The computer program product stored on a non-transitory computer readable storage medium according to claim 9, wherein constructing the ML-CSC model comprises: proposing a CSC model to perform SC on a whole image, wherein the image is obtained by performing convolution on m local filters dᵢ∈Rⁿ(n<<N) and corresponding feature maps γᵢ∈R^{N} thereof and linearly combining resultant convolution results, which is expressed as
$$x = {\sum }_{i = 1}^{m} {d}_{i} = {γ}_{i} ;$$
and corresponding to equation (1), an optimization problem of the CSC model is written as:
$${min}_{{γ}_{i}} \frac{1}{2} {‖ y - {\sum }_{i = 1}^{m} {d}_{i} * {γ}_{i} ‖}_{2}^{2} + α {‖ {\sum }_{i = 1}^{m} {γ}_{i} ‖}_{1} ; \qquad ( 3 )$$
and
converting the filters into a banded circulant matrix to construct a special global convolutional dictionary D∈R^{N×mN}, thereby x=Dγ, wherein in the global convolutional dictionary D, all small blocks each serve as a local dictionary, and have a same size of n×m elements, with filters {dᵢ}ᵢ₌₁^{m} as respective columns; the CSC model (3) is considered as a special form of an SC model (1), matrix multiplication in equation (2) of the ISTA is replaced by a convolution operation, and the CSC problem (3) are also solved by the LISTA.

12. The computer program product stored on a non-transitory computer readable storage medium according to claim 9, wherein constructing the ML-CSC model further comprises:
proposing a relationship between a CNN and a CSC model, wherein a thresholding operator is a basis of the CNN and the CSC model; by comparing a ReLU in the CNN with a soft thresholding function, the ReLU and the soft thresholding function keep consistent in a non-negative part; and for a non-negative CSC model, a corresponding optimization problem (1) is added with a constraint to allow a result to be positive:
$${min}_{γ} \frac{1}{2} ‖ y - {D}_{γ} {‖}_{2}^{2} + α {‖ γ ‖}_{1} s . t . γ \geq 0. \qquad ( 4 )$$
for a given signal y=Dγ, the signal is written as:
y=Dγ₊+(−D)(−γ₋) (5)
wherein, γ is divided into γ+ and γ−, γ+ comprises a positive element, γ− comprises a negative element, and both the γ+ and the −γ− are non-negative; a non-negative sparse representation [γ+ −γ−]^{T} is allowable for the signal y in a dictionary [D-D]; and each SC is converted into NNSC, and the NNSC problem (4) is also solved by the soft thresholding algorithm; and a non-negative soft thresholding operator Sρ⁺ is defined as:
$${S}_{ρ}^{+} ( z ) = \{ \begin{matrix}0 , & z \leq ρ \\ z - ρ , & z > ρ\end{matrix} .$$
assuming that γ⁰=0, an iteration update of γ in the problem (4) is written as:
$${γ}^{1} = {S}_{\frac{α}{L}}^{+} ( \frac{1}{L} ( {D}^{T} y ) ) \qquad ( 6 )$$
the non-negative soft thresholding operator is equivalent to an ReLU function:
S_{ρ}⁺(z)=max(z−ρ,0)=ReLU(z−ρ) (7)
the equation (6) is equivalently written as:
$$\begin{matrix}{γ}^{1} = {S}_{\frac{α}{L}}^{+} ( \frac{1}{L} ( {D}^{T} y ) ) \\ = ReLU ( {W}_{y} - b )\end{matrix} \qquad ( 8 )$$
wherein, a bias vector b corresponds to a threshold
$$\frac{α}{L} ,$$
and α is a hyper-parameter in the SC, but a learning parameter in the CNN; dictionary learning is completed through D=W^{T}; and the non-negative soft thresholding operator for the CSC model is closely associated with the CNN.

13. The computer program product stored on a non-transitory computer readable storage medium according to claim 9, wherein constructing the ML-CSC model further comprises:
proposing the ML-CSC model, wherein a convolutional dictionary D is decomposed into multiplication of multiple matrices, x=D₁D₂ . . . D_{LγL}, and describing the ML-CSC model as:
$$x = {D}_{1} {γ}_{1}$$
$${γ}_{1} = {D}_{2} {γ}_{2}$$
$${γ}_{2} = {D}_{3} {γ}_{3}$$
$$…$$
$${γ}_{L - 1} = {D}_{L} {γ}_{L} .$$
wherein, γᵢ is a sparse representation of an ith layer and also a signal of an (i+1)th layer, and Dᵢ, is a convolutional dictionary of the ith layer and a transpose of a convolutional matrix; an effective dictionary {Dᵢ}ᵢ₌₁^{L} serves as an analysis operator for causing a sparse representation of a shallow layer to be less sparse; different representation layers are used in an analysis-based prior and a synthesis-based prior, such that prior information not only constrains a sparsity of a sparse representation of a deepest layer, but also allows the sparse representation of the shallow layer to be less sparse; the ML-CSC is also a special form of an SC(1) model; and for a given signal γₒ=y, an optimization object of the ith layer in the ML-CSC model is written as:
$${min}_{{γ}_{i}} \frac{1}{2} {‖ {γ}_{i - 1} - {D}_{i} {γ}_{i} ‖}_{2}^{2} + {α}_{i} {‖ {γ}_{i} ‖}_{1} \qquad ( 9 )$$
wherein, αᵢ is a regularization parameter of the ith layer; similar to equation (2), the ISTA is used to obtain an update of γₗ in the problem (9); the ISTA is repeated to obtain an ML-ISTA of {γᵢ}ᵢ₌₁^{L}, and the ML-ISTA converges at a rate of
$$O ( \frac{1}{k} )$$
to a globally optimal solution of the ML-CSC.

14. The computer program product stored on a non-transitory computer readable storage medium according to claim 9, wherein constructing the ML-CSC model further comprises: proposing the ML-LISTA which is configured to be approximate to a SC of the ML-ISTA through learning parameters from data, wherein, (I−Wᵢ^{T}Wᵢ)\hat{γ}ᵢ+Bᵢ^{T}γᵢ₋₁^{k+1} replaces an iterative operator
$$( I - \frac{1}{{L}_{i}} {D}_{i}^{T} {D}_{i} ) {\hat{γ}}_{i} + \frac{1}{{L}_{i}} {D}_{i}^{T} {γ}_{i - 1}^{k + 1} ;$$
a dictionary Dᵢ, in the ML-LISTA is decomposed into two dictionaries Wᵢ, and Bᵢ with a same size, and each of the dictionaries Wᵢ and Bᵢ is also constrained as a convolutional dictionary to control a number of parameters; and if a deepest sparse representation with an initial condition of γ_{L}¹=0 is found through only one iteration, the representation is rewritten as:
γL=P_{ρL}((B_{L}^{T}P_{ρL-1}( . . . P_{ρ1}(B₁^{T}y)))) (10).

15. The computer program product stored on a non-transitory computer readable storage medium according to claim 9, wherein if a non-negative assumption similar to equation (4) is made to a sparse representation coefficient, a thresholding operator P is a non-negative projection; a process of obtaining a deepest sparse representation is equivalent to that of obtaining a stable solution of a neural network, namely forwarding propagation of the CNN is a tracing algorithm for obtaining a sparse representation with a given input signal; a dictionary Di in the ML-CSC model is embedded into a learnable convolution kernel of each of Wi and Bi, a dictionary atom in Bᵢ^{T} (or Wᵢ^{T}) represents a convolutional filter in the CNN, and each of the Wi and the Bi is modeled with an independent convolutional kernel; and a threshold ρᵢ is parallel to a bias vector bᵢ and a non-negative soft thresholding operator is equivalent to an activation function ReLU of the CNN.

16. The computer program product stored on a non-transitory computer readable storage medium according to claim 9, wherein the SRMCSC network comprises two parts: an ML-LISTA feature extraction part and an HR image reconstruction part; the network is an end-to-end system, with a LR image y as an input, and a directly generated and real HR image x as an output; and a depth of the network is only related to a number of iterations;
each layer and each skip connection in the SRMCSC network strictly correspond to each step of a processing flow of a three-layer LISTA, an unfolded algorithm framework of the three-layer LISTA serves as a first constituent part of the SRMCSC network, and first three layers of the network correspond to a first iteration of the algorithm; a middle hidden layer having an iterative update in the network comprises update blocks; a sparse feature mapping γ₃^{K} is obtained through K iterations; and a residual image is estimated according to a definition of the ML-CSC model and in combination with the sparse feature mapping and a dictionary, an estimated residual image U mainly comprising highly frequent detail information, and a final HR image x is obtained through equation (11) to serve as a second constituent part of the network;
x=U+y (11)
performance of the network only depends on an initial value of a parameter, a number of iterations K and a number of filters; and in other words, thereof the network only increases the number of iterations without introducing an additional parameter, and parameters of the filters to be trained by the model only comprise three dictionaries with a same size; and
a loss function that is a MSE is used in the SRMCSC network: N training pairs {yᵢ, xᵢ}ᵢ₌₁^{N}, namely LR-HR patch pairs, is given to minimize a following objective function:
$$L ( Θ ) = {\sum }_{i = 1}^{N} {‖ f ( {y}_{i} ; Θ ) - {x}_{i} ‖}_{F}^{2} ;$$
wherein, ƒ(·) is the SRMCSC network, Θ represents all trainable parameters, and an Adam optimization program is used to optimize the parameters of the network.

17. A non-transitory computer readable storage medium, storing instructions, and configured to enable, when run on a computer, the computer to execute the SR image reconstruction method based on DCSC according to claim 1, the method comprising following steps:
embedding ML-LISTA of a ML-CSC model into DCNN, adaptively updating all parameters of the ML-LISTA with a learning ability of the DCNN, and constructing an SRMCSC network which is an interpretable end-to-end supervised neural network for SR image reconstruction; and
introducing residual learning, extracting a residual feature with the ML-LISTA, and reconstructing a HR image in combination with the residual feature and an input image, thereby accelerating a training speed and a convergence speed of the SRMCSC network.

18. The non-transitory computer readable storage medium according to claim 17, wherein in the constructing the ML-CSC model, SC is implemented to find a sparsest representation γ∈R^{M} of a signal y∈R^{N} in a given overcomplete dictionary A∈R^{N×M}(M>N), which is expressed as y=Aγ; and a γ problem which is also called a Lasso or [symbol] 1-regularization backpropagation (BP) problem is solved:
$${min}_{γ} \frac{1}{2} {‖ y - A γ ‖}_{2}^{2} + α {‖ γ ‖}_{1} \qquad ( 1 )$$
wherein, a constant α is used to weigh a reconstruction item and a regularization item; and an update equation of an ISTA is written as:
$$\begin{matrix}{γ}^{i + 1} = {S}_{\frac{α}{L}} ( {γ}^{i} - \frac{1}{L} ( - {A}^{T} y + {A}^{T} A {γ}^{i} ) ) \\ = {S}_{\frac{α}{L}} ( \frac{1}{L} {A}^{T} y + ( I - \frac{1}{L} {A}^{T} A ) {γ}^{i} )\end{matrix} \qquad ( 2 )$$
wherein, γⁱ represents an ith iteration update, L is a Lipschitz constant, and Sρ(·)is a soft thresholding operator with a threshold ρ; and the soft thresholding operator is defined as follows:
$${S}_{ρ} ( z ) = \{ \begin{matrix}z + ρ , & z < - ρ \\ 0. & - ρ \leq z \leq ρ \\ z - ρ , & z > ρ\end{matrix} .$$

19. The non-transitory computer readable storage medium according to claim 17, wherein constructing the ML-CSC model comprises: proposing a CSC model to perform SC on a whole image, wherein the image is obtained by performing convolution on m local filters dᵢ∈Rⁿ(n<<N) and corresponding feature maps γᵢ∈R^{N} thereof and linearly combining resultant convolution results, which is expressed as
$$x = {\sum }_{i = 1}^{m} {d}_{i} = {γ}_{i} ;$$
and corresponding to equation (1), an optimization problem of the CSC model is written as:
$${min}_{{γ}_{i}} \frac{1}{2} {‖ y - {\sum }_{i = 1}^{m} {d}_{i} * {γ}_{i} ‖}_{2}^{2} + α {‖ {\sum }_{i = 1}^{m} {γ}_{i} ‖}_{1} ; \qquad ( 3 )$$
and
converting the filters into a banded circulant matrix to construct a special global convolutional dictionary D∈R^{N×mN}, thereby x=Dγ, wherein in the global convolutional dictionary D, all small blocks each serve as a local dictionary, and have a same size of n×m elements, with filters {dᵢ}ᵢ₌₁^{m} as respective columns; the CSC model (3) is considered as a special form of an SC model (1), matrix multiplication in equation (2) of the ISTA is replaced by a convolution operation, and the CSC problem (3) are also solved by the LISTA.

20. The non-transitory computer readable storage medium according to claim 17, wherein constructing the ML-CSC model further comprises: proposing a relationship between a CNN and a CSC model, wherein a thresholding operator is a basis of the CNN and the CSC model; by comparing a ReLU in the CNN with a soft thresholding function, the ReLU and the soft thresholding function keep consistent in a non-negative part; and for a non-negative CSC model, a corresponding optimization problem (1) is added with a constraint to allow a result to be positive:
$${min}_{γ} \frac{1}{2} {‖ y - D γ ‖}_{2}^{2} + α {‖ γ ‖}_{1} s . t . γ \geq 0. \qquad ( 4 )$$
for a given signal y=Dγ, the signal is written as:
y=Dγ₊+(−D)(−γ₋) (5)
wherein, γ is divided into γ+ and γ−, γ+ comprises a positive element, γ− comprises a negative element, and both the γ+ and the −γ− are non-negative; a non-negative sparse representation [γ+ −γ−]^{T} is allowable for the signal y in a dictionary [D-D]; and each SC is converted into NNSC, and the NNSC problem (4) is also solved by the soft thresholding algorithm; and a non-negative soft thresholding operator Sρ⁺ is defined as:
$${S}_{ρ}^{+} ( z ) = \{ \begin{matrix}0 , & z \leq ρ \\ z - ρ , & z > ρ\end{matrix} .$$
assuming that γ⁰=0, an iteration update of γ in the problem (4) is written as:
$${γ}^{1} = {S}_{\frac{α}{L}}^{+} ( \frac{1}{L} ( {D}^{T} y ) ) \qquad ( 6 )$$
the non-negative soft thresholding operator is equivalent to an ReLU function:
S_{ρ}⁺(z)=max(z−ρ, 0)=ReLU(z−ρ) (7)
the equation (6) is equivalently written as:
$$\begin{matrix}{γ}^{1} = {S}_{\frac{α}{L}}^{+} ( \frac{1}{L} ( {D}^{T} y ) ) \\ = ReLU ( {W}_{y} - b )\end{matrix} \qquad ( 8 )$$
wherein, a bias vector b corresponds to a threshold
$$\frac{α}{L} ,$$
and α is a hyper-parameter in the SC, but a learning parameter in the CNN; dictionary learning is completed through D=W^{T}; and the non-negative soft thresholding operator for the CSC model is closely associated with the CNN.
